(19) United States
(12) Patent Application Publication
(10) Pub. No.: US 2024/0221367 A1
(43) Pub. Date: Jul. 4, 2024

(54) IMAGE GENERATION METHOD, PROCESSOR, AND PROGRAM

(71) Applicant: FUJIFILM Corporation, Tokyo (JP)

(72) Inventor: Yuya NISHIO, Saitama-shi (JP)

(73) Assignee: FUJIFILM Corporation, Tokyo (JP)

(21) Appl. No.: 18/607,541

(22) Filed: Mar. 17, 2024

Related U.S. Application Data
(63) Continuation of application No. PCT/JP2022/027949, filed on Jul. 15, 2022.

(30) Foreign Application Priority Data
Sep. 27, 2021 (JP) 2021-157103

(51) Int. Cl. G06V 10/774; H04N 23/63; H04N 23/667; H04N 23/84

(52) U.S. Cl. CPC G06V 10/774; H04N 23/63; H04N 23/667; H04N 23/843

(57) ABSTRACT

An image generation method includes: an imaging step of acquiring an imaging signal output from an imaging element; a first generation step of using the imaging signal to generate a first image through first image processing; a detection step of detecting a subject within the first image by using the first image via a trained model trained through machine learning; and a second generation step of using the imaging signal to generate a second image through second image processing different from the first image processing.

### CROSS-REFERENCE TO RELATED APPLICATION

This application is a continuation application of International Application No. PCT/JP2022/027949, filed Jul. 15, 2022, the disclosure of which is incorporated herein by reference in its entirety. Further, this application claims priority from Japanese Patent Application No. 2021-157103 filed on Sep. 27, 2021, the disclosure of which is incorporated herein by reference in its entirety.

### BACKGROUND

### 1. Technical Field

The technology of the present disclosure relates to an image generation method, a processor, and a program.

### 2. Description of the Related Art

JP2020-123174A discloses an image file generation apparatus that generates an image file having image data and metadata, the image file generation apparatus including a file creation unit that provides, information as to whether to use the image data as external-request learning training data or as confidential reference data as the metadata in a case of creating an inference model that receives an image related to the image data as an input.

JP2020-166744A discloses a learning apparatus including a first inference model creation unit that is provided with first learning request data including an image acquired by a first device and information regarding a first inference engine of the first device and that creates a first inference model which is available in the first inference engine of the first device through training using training data based on the image, and a second inference model creation unit that is provided with second learning request data including information related to a second inference engine of a second device and that creates a second inference model by adapting the first inference model to the second inference engine of the second device.

JP2019-146022A discloses an imaging apparatus including an imaging unit that acquires an image signal by imaging a specific range, a storage unit that stores a plurality of target object image dictionaries which correspond to the plurality of types of target objects, respectively, an inference engine that discriminates a type of a specific target object based on the image signal acquired by the imaging unit and the plurality of target object image dictionaries stored in the storage unit and that selects a target object image dictionary corresponding to the discriminated type of the specific target object from among the plurality of target object image dictionaries, and an imaging control unit that performs imaging control based on the image signal acquired by the imaging unit and the target object image dictionary selected by the inference engine.

### SUMMARY

One embodiment according to the technology of the present disclosure provides an image generation method, an imaging apparatus, and a program that enable enhancement of detection accuracy of a subject.

In order to achieve the above-described object, according to the present disclosure, there is provided an image generation method comprising: an imaging step of acquiring an imaging signal output from an imaging element; a first generation step of using the imaging signal to generate a first image through first image processing; a detection step of detecting a subject within the first image by using the first image via a trained model trained through machine learning; and a second generation step of using the imaging signal to generate a second image through second image processing different from the first image processing.

It is preferable that a reception step of receiving an imaging instruction from a user is further provided, and in the second generation step, the second image is generated in a case where the imaging instruction is received in the reception step.

It is preferable that a display step of changing the first image to create a live view image and displaying the live view image and a detection result of the subject detected in the detection step on a display device is further provided.

It is preferable that, in the display step, the live view image is displayed by generating a display signal of the live view image based on an image signal constituting the first image.

It is preferable that, in the second generation step, a color of the second image is made substantially the same as a color of the live view image.

It is preferable that chroma saturation or brightness of the first image is higher than that of the second image and of the live view image.

It is preferable that a recording step of recording the second image on a recording medium as a still image is further provided.

It is preferable that the first image has a lower resolution than that of the imaging signal or the second image.

It is preferable that, in the imaging step, the imaging signal is output from the imaging element for each frame period, in the first generation step and the second generation step, the first image and the second image are generated by using the imaging signal of the same frame period of time, and the first image has a lower resolution than that of the imaging signal or the second image.

It is preferable that the second image has a lower resolution than that of the imaging signal.

It is preferable that, in the imaging step, the imaging signal is output from the imaging element for each frame period, in the first generation step, the first image is generated by using the imaging signal of a first frame period of time, and in the second generation step, the second image is generated by using the imaging signal of a second frame period of time different from the first frame period of time.

It is preferable that the second image is a moving image.

It is preferable that chroma saturation or brightness of the first image is higher than that of the second image.

It is preferable that the trained model is a model trained through machine learning using a color image as training data, the first image is a color image, and the second image is a monochrome image or a sepia image.

According to the present disclosure, there is provided a processor that acquires an imaging signal output from an imaging apparatus, the processor configured to execute: a first generation process of using the imaging signal to generate a first image through first image processing; a detection process of detecting a subject within the first image by using the first image via a trained model trained through machine learning; and a second generation process of using the imaging signal to generate a second image through second image processing different from the first image processing.

According to the present disclosure, there is provided a program used by a processor that acquires an imaging signal output from an imaging apparatus, the program causing the processor to execute: a first generation process of using the imaging signal to generate a first image through first image processing; a detection process of detecting a subject within the first image by using the first image via a trained model trained through machine learning; and a second generation process of using the imaging signal to generate a second image through second image processing different from the first image processing.

### BRIEF DESCRIPTION OF THE DRAWINGS

Exemplary embodiments according to the technique of the present disclosure will be described in detail based on the following figures, wherein:

FIG. 1 is a diagram showing an example of an internal configuration of an imaging apparatus,

FIG. 2 is a block diagram showing an example of a functional configuration of a processor,

FIG. 3 is a diagram conceptually showing an example of a subject detection process and a display process in a monochrome mode,

FIG. 4 is a diagram showing an example of a second image generated by a second image processing unit,

FIG. 5 is a flowchart showing an example of an image generation method by the imaging apparatus,

FIG. 6 is a diagram showing an example of generation timings of a first image and a second image in a video capturing mode,

FIG. 7 is a flowchart showing an example of the image generation method in the video capturing mode,

FIG. 8 is a diagram showing an example of generation timings of a first image and a second image in a video capturing mode according to a modification example,

FIG. 9 is a flowchart showing an example of the image generation method in the video capturing mode according to the modification example, and

FIG. 10 is a diagram showing an example of generation timings of a first image and a second image in a video capturing mode according to another modification example.

### DETAILED DESCRIPTION

An example of an embodiment according to the technology of the present disclosure will be described with reference to the accompanying drawings.

First, the terms used in the following description will be described.

In the following description, “IC” is an abbreviation of “integrated circuit”. “CPU” is an abbreviation of “central processing unit”. “ROM” is an abbreviation of “read only memory”. “RAM” is an abbreviation of “random access memory”. “CMOS” is an abbreviation of “complementary metal oxide semiconductor”.

“FPGA” is an abbreviation of “field programmable gate array”. “PLD” is an abbreviation of “programmable logic device”. “ASIC” is an abbreviation of “application specific integrated circuit”. “OVF” is an abbreviation of “optical view finder”. “EVF” is an abbreviation of “electronic view finder”. “JPEG” is an abbreviation of “joint photographic experts group”.

As an embodiment of an imaging apparatus, the technology of the present disclosure will be described using a lens-interchangeable digital camera as an example. It should be noted that the technology of the present disclosure is not limited to the lens-interchangeable type and can also be applied to an integrated-lens digital camera.

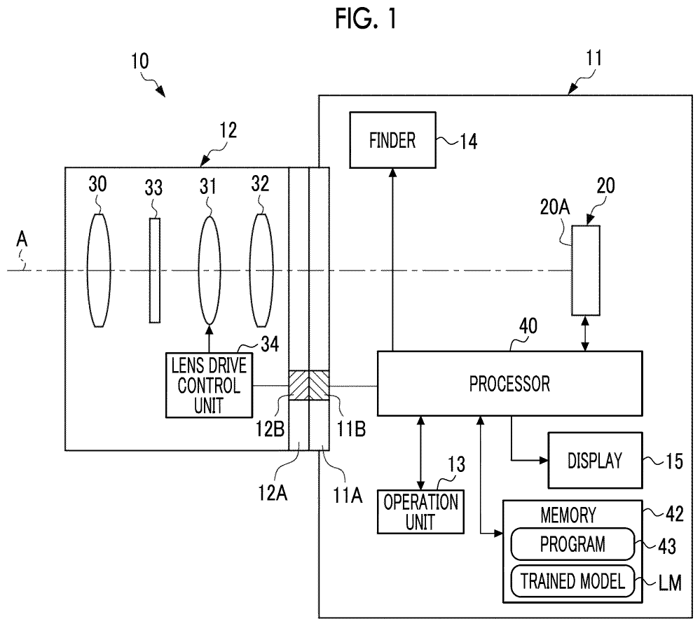

FIG. 1 shows an example of a configuration of an imaging apparatus 10. The imaging apparatus 10 is a lens-interchangeable digital camera. The imaging apparatus 10 is composed of a body 11 and an imaging lens 12 that is interchangeably mounted on the body 11. The imaging lens 12 is attached to a front surface side of the body 11 via a camera-side mount 11A and a lens-side mount 12A.

The body 11 is provided with an operation unit 13 including a dial, a release button, and the like. Examples of an operation mode of the imaging apparatus 10 include a still image capturing mode, a video capturing mode, and an image display mode. The operation unit 13 is operated by a user in a case of setting the operation mode. In addition, the operation unit 13 is operated by the user in a case of starting the execution of still image capturing or video capturing.

Further, through the operation unit 13, it is possible to perform settings such as an image size, an image quality mode, a recording method, a color tone adjustment such as film simulation, a dynamic range, and white balance. The film simulation is a mode in which color reproduction and gradation expression are set in a sensation of replacing films in accordance with the user's imaging intention. In film simulation, various modes for reproducing films, such as vivid, soft, classic chrome, sepia, and monochrome, can be selected, and the color tone of the image can be adjusted.

Additionally, the body 11 is provided with a finder 14. Here, the finder 14 is a hybrid finder (registered trademark). The hybrid finder refers to a finder in which, for example, an optical view finder (hereinafter referred to as “OVF”) and an electronic view finder (hereinafter referred to as “EVF”) are selectively used. The user can observe an optical image or a live view image of the subject projected onto the finder 14 via a finder eyepiece portion (not shown).

In addition, the display 15 is provided on a rear surface side of the body 11. The display 15 displays an image based on an image signal obtained through imaging, various menu screens, or the like. Instead of the finder 14, the user can also observe the live view image projected onto the display 15. The finder 14 and the display 15 are each an example of a “display device” according to the technology of the present disclosure.

The body 11 and the imaging lens 12 are electrically connected to each other through contact between an electrical contact 11B provided on the camera-side mount 11A and an electrical contact 12B provided on the lens-side mount 12A.

The imaging lens 12 includes an objective lens 30, a focus lens 31, a rear-end lens 32, and a stop 33. Respective members are arranged in the order of the objective lens 30, the stop 33, the focus lens 31, and the rear-end lens 32 from an objective side along an optical axis A of the imaging lens 12. The objective lens 30, the focus lens 31, and the rear-end lens 32 constitute an imaging optical system. The type, the number, and the arrangement order of the lenses constituting the imaging optical system are not limited to the example shown in FIG. 1.

Moreover, the imaging lens 12 has a lens drive control unit 34. The lens drive control unit 34 includes, for example, a CPU, a RAM, a ROM, and the like. The lens drive control unit 34 is electrically connected to a processor 40 inside the body 11 via the electrical contact 12B and the electrical contact 11B.

The lens drive control unit 34 drives the focus lens 31 and the stop 33 based on a control signal transmitted from the processor 40. The lens drive control unit 34 performs drive control of the focus lens 31 based on a control signal for focusing control transmitted from the processor 40, in order to adjust a focusing position of the imaging lens 12. The processor 40 may perform the focusing control based on a detection result R detected through the subject detection, which will be described below.

The stop 33 has an opening in which an opening diameter is variable with the optical axis A as a center. The lens drive control unit 34 performs drive control of the stop 33 based on a control signal for stop adjustment transmitted from the processor 40, in order to adjust the amount of light incident on a light-receiving surface 20A of an imaging sensor 20.

Further, the imaging sensor 20, the processor 40, and a memory 42 are provided inside the body 11. The operations of the imaging sensor 20, the memory 42, the operation unit 13, the finder 14, and the display 15 are controlled by the processor 40.

The processor 40 includes, for example, a CPU, a RAM, a ROM, and the like. In such a case, the processor 40 executes various types of processing based on a program 43 stored in the memory 42. The processor 40 may include an assembly of a plurality of IC chips. In addition, the memory 42 stores a trained model LM that has been trained through machine learning for performing the subject detection.

The imaging sensor 20 is, for example, a CMOS-type image sensor. The imaging sensor 20 is disposed such that the optical axis A is orthogonal to the light-receiving surface 20A and the optical axis A is positioned at the center of the light-receiving surface 20A. Light (subject image) that has passed through the imaging lens 12 is incident on the light-receiving surface 20A. A plurality of pixels for generating image signals through photoelectric conversion are formed on the light-receiving surface 20A. The imaging sensor 20 generates and outputs the image signal by photoelectrically converting the light incident on each pixel. The imaging sensor 20 is an example of an “imaging element” according to the technology of the present disclosure.

Further, a Bayer array color filter array is disposed on the light-receiving surface of the imaging sensor 20, and any of a red (R), green (G), or blue (B) color filter is disposed to face each pixel. Some of the plurality of pixels arranged on the light-receiving surface of the imaging sensor 20 may be phase difference pixels for performing focusing control.

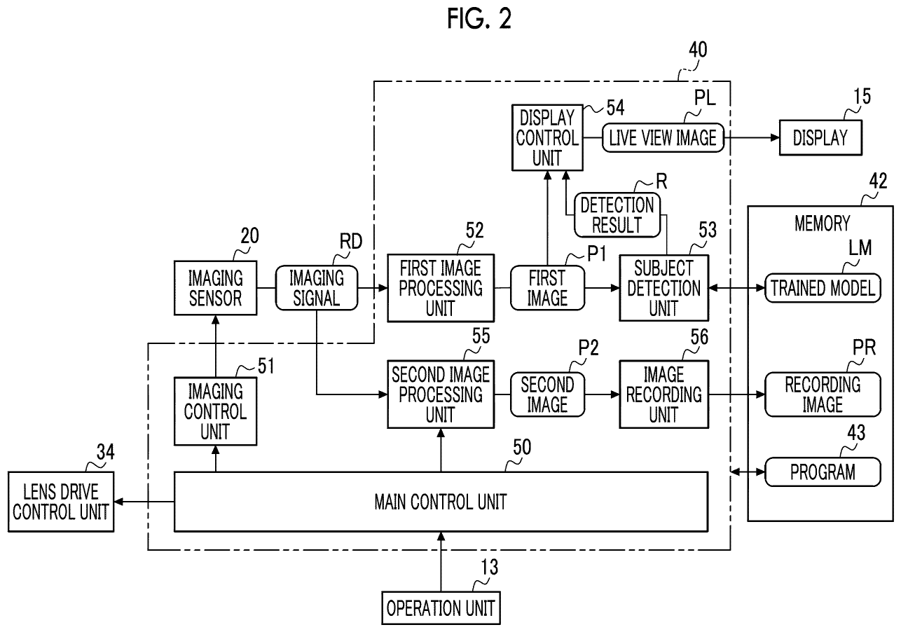

FIG. 2 shows an example of a functional configuration of the processor 40. The processor 40 implements various functional units by executing processing in accordance with the program 43 stored in the memory 42. As shown in FIG. 2, for example, a main control unit 50, an imaging control unit 51, a first image processing unit 52, a subject detection unit 53, a display control unit 54, a second image processing unit 55, and an image recording unit 56 are implemented by the processor 40.

The main control unit 50 comprehensively controls operations of the imaging apparatus 10 based on instruction signals input through the operation unit 13. The imaging control unit 51 executes an imaging process of causing the imaging sensor 20 to perform an imaging operation by controlling the imaging sensor 20. The imaging control unit 51 drives the imaging sensor 20 in the still image capturing mode or the video capturing mode. The imaging sensor 20 outputs an imaging signal RD generated by the imaging operation. The imaging signal RD is so-called RAW data.

The first image processing unit 52 performs a first generation process of acquiring the imaging signal RD output from the imaging sensor 20 and performing first image processing including a demosaicing process and the like on the imaging signal RD to generate a first image P1. For example, the first image P1 is a color image in which each pixel is represented by three primary colors, that is, R, G, and B. More specifically, for example, the first image P1 is a 24-bit color image in which each signal of R, G, and B included in one pixel is represented by 8 bits.

The subject detection unit 53 performs a detection process of detecting the subject within the first image P1 by using the first image P1 generated by the first image processing unit 52 via the trained model LM stored in the memory 42. Specifically, the subject detection unit 53 inputs the first image P1 to the trained model LM and acquires the detection result R of the subject from the trained model LM. The subject detection unit 53 outputs the acquired detection result R of the subject to the display control unit 54. Further, the detection result R of the subject is also used by the main control unit 50 for the focus adjustment of the imaging lens 12 or the exposure adjustment of the subject.

The subject detected by the subject detection unit 53 includes a background such as a sky or a sea in addition to a specific object such as a person or a vehicle. Further, the subject detection unit 53 may detect a specific scene such as a wedding or a festival based on the detected subject.

The trained model LM is composed of, for example, a neural network, and has been trained in advance through machine learning using a plurality of images including a specific subject as training data. The trained model LM detects a region including the specific subject from within the first image P1 and outputs the detected region as the detection result R. The trained model LM may output the region including the subject and a type of the subject.

The display control unit 54 performs a display process of changing the first image P1 to create a live view image PL and displaying the created live view image PL and the detection result R input from the subject detection unit 53 on the display 15. Specifically, the display control unit 54 generates a display signal of the live view image PL based on the image signal constituting the first image P1 to display the live view image PL on the display 15.

The display control unit 54 is, for example, a display driver that performs color adjustment of the display 15. The display control unit 54 adjusts color of the display signal of the live view image PL displayed on the display 15 according to the selected mode. For example, in a case where the monochrome mode in the film simulation is selected, the display control unit 54 sets the chroma saturation of the display signal of the live view image PL to zero to display the monochrome live view image PL on the display 15. For example, in a case where the image signal is represented in a YCbCr format, the display control unit 54 sets the color difference signals Cr and Cb to zero to make the display signal monochrome. In the present disclosure, “monochrome” means substantially achromatic colors including grayscale.

The display control unit 54 displays the live view image PL and the detection result R not only on the display 15 but also on the finder 14 in response to the user's operation on the operation unit 13.

The second image processing unit 55 performs a second generation process of acquiring the imaging signal RD output from the imaging sensor 20 and performing second image processing, which is processing including a demosaicing process and is different from the first image processing, on the imaging signal RD to generate a second image P2. Specifically, the second image processing unit 55 makes a color of the second image P2 substantially the same as a color of the live view image PL. For example, in a case where the monochrome mode in the film simulation is selected, the second image processing unit 55 generates the achromatic second image P2 through the second image processing. For example, the second image P2 is a monochrome image in which one pixel signal is represented by 8 bits. The first image P1 and the second image P2 may be imaging signals output at temporally different timings (that is, different imaging frames).

The main control unit 50 performs a reception process of receiving an imaging instruction from the user via the operation unit 13. The second image processing unit 55 performs processing of generating the second image P2 in a case where the main control unit 50 receives the imaging instruction from the user. The imaging instruction includes a still image capturing instruction and a video capturing instruction.

The image recording unit 56 performs a recording process of recording the second image P2 generated by the second image processing unit 55 in the memory 42 as a recording image PR. Specifically, in a case where the still image capturing instruction received by the main control unit 50 is received, the image recording unit 56 records the recording image PR in the memory 42 as a still image composed of one second image P2. Further, in a case where the video capturing instruction received by the main control unit 50 is received, the image recording unit 56 records the recording image PR in the memory 42 as a moving image composed of a plurality of second images P2. The image recording unit 56 may record the recording image PR on a recording medium (for example, a memory card that can be attached to and detached from the body 11) different from the memory 42.

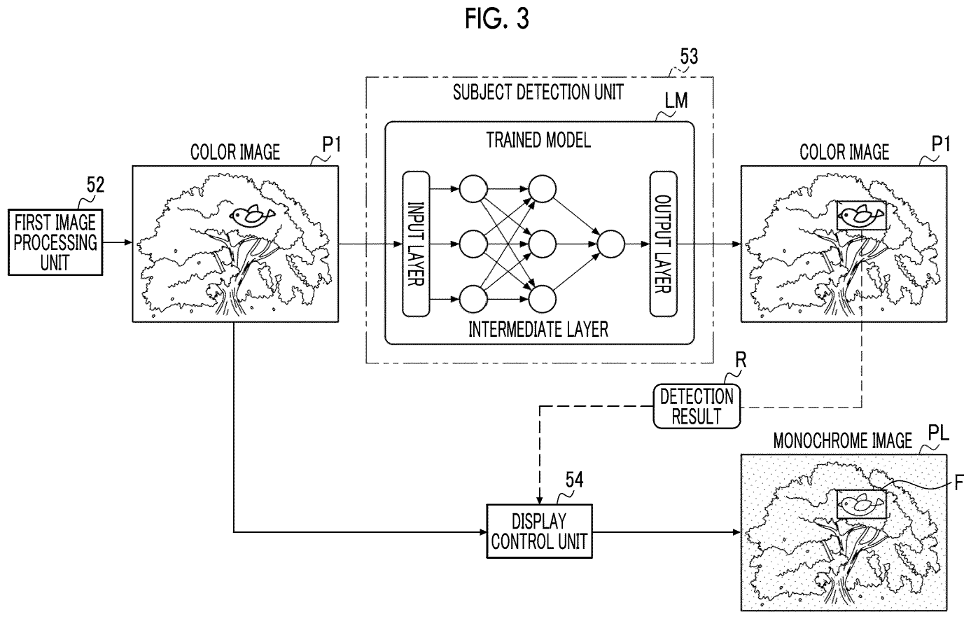

FIG. 3 conceptually shows an example of the subject detection process and the display process in the monochrome mode. As shown in FIG. 3, the trained model LM is composed of a neural network having an input layer, an intermediate layer, and an output layer. The intermediate layer is composed of a plurality of neurons. The number of intermediate layers and the number of neurons in each intermediate layer can be changed as appropriate.

The trained model LM has been trained through machine learning using a color image including the specific subject as training data to detect a specific subject from within the image. For example, an error back-propagation learning method is used as a machine learning method. The trained model LM may be trained through machine learning on a computer outside the imaging apparatus 10.

Since the trained model LM has been trained through machine learning mainly using the color image, the detection accuracy of the subject is low for a monochrome image not including color information. Therefore, in a case where the monochrome image generated by the image processing is input to the trained model LM as it is in the monochrome mode, the detection accuracy of the subject may decrease. In that respect, in the technology of the present disclosure, the subject detection unit 53 detects the subject by inputting the first image P1 that is a color image generated by the first image processing unit 52 into the trained model LM even in the monochrome mode in which the live view image PL and the recording image PR are monochrome.

For example, as shown in FIG. 3, in a case where a bird is the subject and there is a tree behind the subject, it may be difficult to discriminate the bird from the tree in a case of a monochrome image in which there is no color information, which leads to a decrease in detection accuracy by the trained model LM. Even in such a case, the detection accuracy is improved by inputting the color image into the trained model LM.

In the example shown in FIG. 3, the trained model LM detects a region including the bird serving as the subject from within the first image P1 and outputs region information thereof to the display control unit 54 as the detection result R. The display control unit 54 displays, based on the detection result R, a frame F corresponding to the region including the detected subject, within the live view image PL. The display control unit 54 may display the type of the subject in the vicinity of the frame F or the like. The detection result R of the subject is not limited to the frame F and may be a name of the subject or a name of a scene based on the detection results of a plurality of subjects.

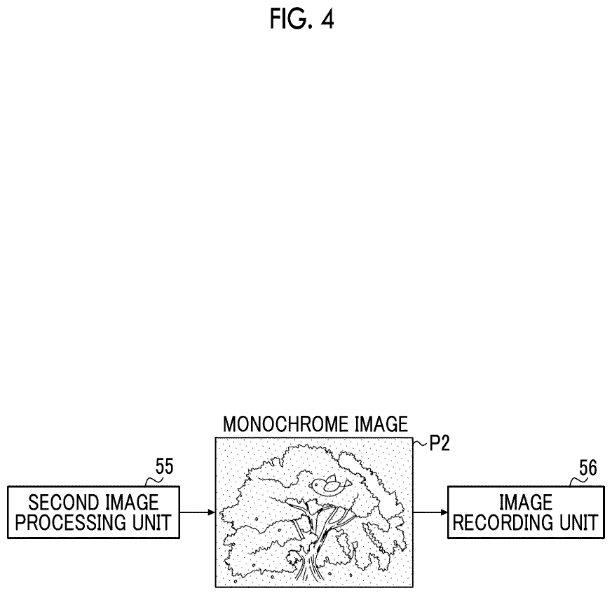

FIG. 4 shows an example of the second image P2 generated by the second image processing unit 55. The color of the second image P2 generated by the second image processing unit 55 is substantially the same as the color of the live view image PL and is monochrome in a case of the monochrome mode.

### Still Image Capturing Mode

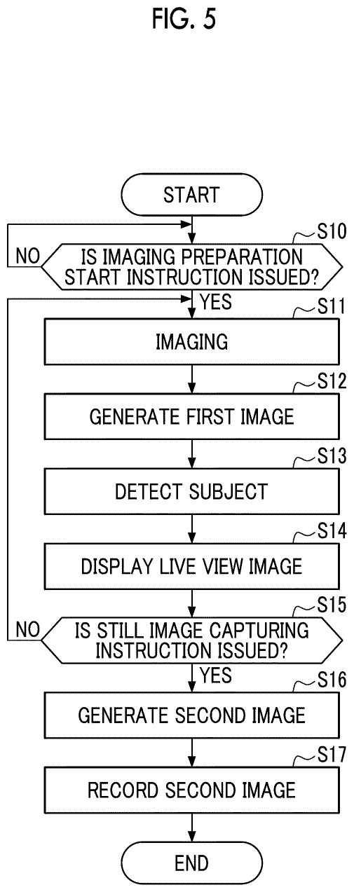

FIG. 5 is a flowchart showing an example of an image generation method by the imaging apparatus 10. FIG. 5 shows an example of a case where the monochrome mode of the film simulation is selected in the still image capturing mode.

The main control unit 50 determines whether or not an imaging preparation start instruction is issued by the user through the operation of the operation unit 13 (step S10). In a case where the imaging preparation start instruction is issued (step S10: YES), the main control unit 50 controls the imaging control unit 51 to cause the imaging sensor 20 to perform the imaging operation (step S11).

The first image processing unit 52 acquires the imaging signal RD, which is output from the imaging sensor 20 through the imaging operation of the imaging sensor 20, and performs the first image processing on the imaging signal RD to generate the first image P1, which is a color image (step S12).

The subject detection unit 53 detects the subject by inputting the first image P1 generated by the first image processing unit 52 into the trained model LM (step S13). In step S13, the subject detection unit 53 outputs the detection result R of the subject, which is output from the trained model LM, to the display control unit 54.

The display control unit 54 changes the first image P1 to create the live view image PL, which is a monochrome image, and displays the created live view image PL and the detection result R on the display 15 (step S14).

The main control unit 50 determines whether or not the still image capturing instruction is issued by the user through the operation of the operation unit 13 (step S15). In a case where no still image capturing instruction is issued (step S15: NO), the main control unit 50 returns the processing to step S11 and causes the imaging sensor 20 to perform the imaging operation again. The processing of steps S11 to S14 is repeatedly executed until the main control unit 50 determines that the still image capturing instruction is issued in step S15.

In a case where the still image capturing instruction is issued (step S15: YES), the main control unit 50 causes the second image processing unit 55 to generate the second image P2 (step S16). In step S16, the second image processing unit 55 generates the second image P2, which is a monochrome image, through the second image processing different from the first image processing.

The image recording unit 56 records the second image P2 generated by the second image processing unit 55 in the memory 42 as the recording image PR (step S17).

In the above-described flowchart, step S11 corresponds to an “imaging step” according to the technology of the present disclosure. Step S12 corresponds to a “first generation step” according to the technology of the present disclosure. Step S13 corresponds to a “detection step” according to the technology of the present disclosure. Step S14 corresponds to a “display step” according to the technology of the present disclosure. Step S15 corresponds to a “reception step” according to the technology of the present disclosure. Step S16 corresponds to a “second generation step” according to the technology of the present disclosure. Step S17 corresponds to a “recording step” according to the technology of the present disclosure.

As described above, with the imaging apparatus 10 of the present disclosure, even in the monochrome mode, the subject is detected by inputting the first image P1, which is a color image, into the trained model LM, so that the detection accuracy of the subject is improved.

Conventionally, an algorithm called a classifier “Viola-Jones method” by AdaBoost has been mainly used for the subject detection. In the Viola-Jones method, since the subject detection is performed based on a feature amount derived from a difference in brightness of the image, color information of the image is not important. However, in a case where the neural network is used as the trained model LM, machine learning is performed basically using a color image to extract the feature amount based on brightness information and color information. Therefore, even in the monochrome mode, the detection accuracy of the subject is improved by generating a color image and inputting the color image into the trained model LM.

### Video Capturing Mode

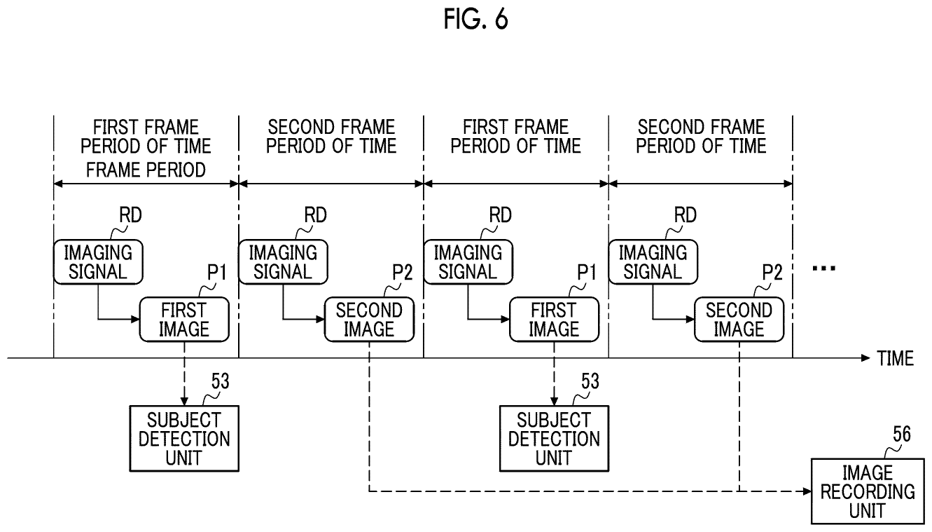

Next, the video capturing mode will be described. FIG. 6 shows an example of generation timings of the first image P1 and the second image P2 in the video capturing mode.

As shown in FIG. 6, in the video capturing mode, the imaging sensor 20 performs the imaging operation for each predetermined frame period (for example, 1/60 seconds) and outputs the imaging signal RD every single frame period. In a case where the first image processing unit 52 and the second image processing unit 55 generate the first image P1 and the second image P2 based on the same imaging signal RD in the same frame period of time, the first image P1 and the second image P2 may not be generated for each frame period because of constraints on image processing capability.

In that respect, in the present example, the generation of the first image P1 by the first image processing unit 52 and the generation of the second image P2 by the second image processing unit 55 are alternately performed every single frame period. That is, the first image processing unit 52 generates the first image P1 by using the imaging signal RD of a first frame period of time, and the second image processing unit 55 generates the second image P2 by using the imaging signal RD of a second frame period of time different from the first frame period of time. As a result, the subject detection is performed every two frame periods. In addition, the frame rate of the moving image generated from the plurality of second images P2 is decreased to ½.

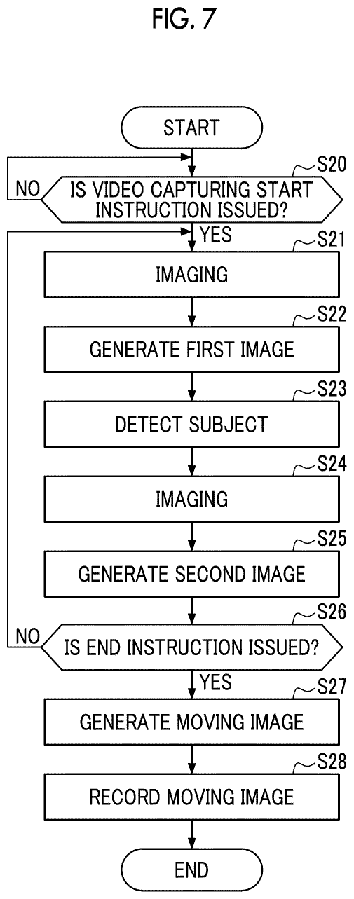

FIG. 7 is a flowchart showing an example of the image generation method in the video capturing mode. FIG. 7 shows an example of a case where the monochrome mode of the film simulation is selected in the video capturing mode.

The main control unit 50 determines whether or not a video capturing start instruction is issued by the user through the operation of the operation unit 13 (step S20). In a case where the video capturing start instruction is issued (step S20: YES), the main control unit 50 controls the imaging control unit 51 to cause the imaging sensor 20 to perform the imaging operation (step S21).

The first image processing unit 52 acquires the imaging signal RD output from the imaging sensor 20 and performs the first image processing on the imaging signal RD to generate the color first image P1 (step S22).

The subject detection unit 53 detects the subject by inputting the first image P1 generated by the first image processing unit 52 into the trained model LM (step S23). In step S23, the subject detection unit 53 outputs the detection result R of the subject, which is output from the trained model LM, to the main control unit 50. For example, the main control unit 50 controls the lens drive control unit 34 based on the detection result R to perform focusing control on the subject.

Next, the main control unit 50 controls the imaging control unit 51 to cause the imaging sensor 20 to perform the imaging operation (step S24). The second image processing unit 55 acquires the imaging signal RD output from the imaging sensor 20 and performs the second image processing on the imaging signal RD to generate the monochrome second image P2 (step S25).

The main control unit 50 determines whether or not an end instruction of the video capturing is issued by the user through the operation of the operation unit 13 (step S26). In a case where no end instruction is issued (step S26: NO), the main control unit 50 returns the processing to step S21 and causes the imaging sensor 20 to perform the imaging operation again. The processing of steps S21 to S25 is repeatedly executed until the main control unit 50 determines that the end instruction is issued in step S26. Steps S21 to S23 are performed in the first frame period of time, and steps S24 and S25 are performed in the second frame period of time.

In a case where the end instruction is issued (step S26: YES), the main control unit 50 causes the image recording unit 56 to generate the recording image PR (step S27). In step S27, the image recording unit 56 generates the recording image PR, which is a moving image, based on the plurality of second images P2 generated by repeatedly executing step S25. Then, the image recording unit 56 records the recording image PR in the memory 42 (step S28).

As described above, by alternately performing the generation of the first image P1 and the generation of the second image P2 every single frame period, it is possible to perform high-precision subject detection and video capturing without being constrained by the constraints on image processing capability.

### Modification Example

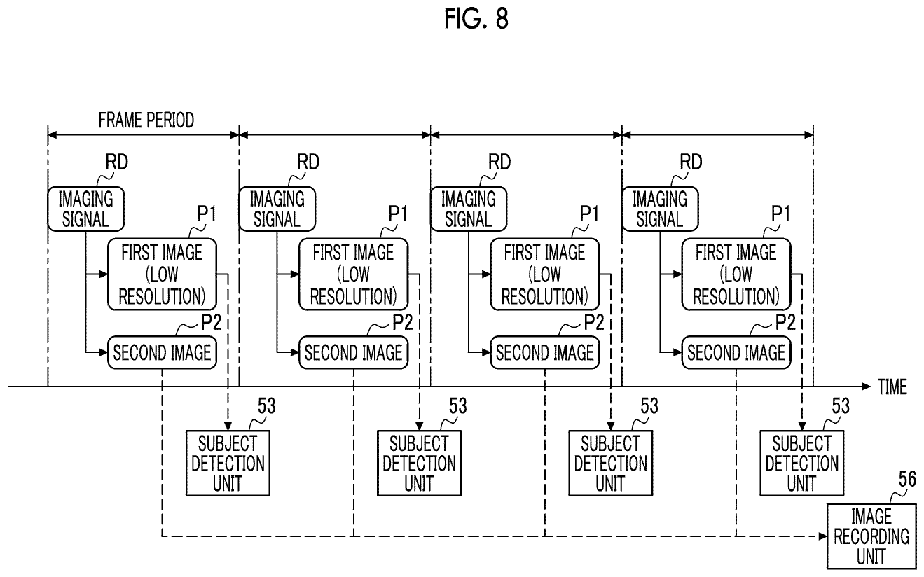

Next, a modification example of the video capturing mode will be described. FIG. 8 shows an example of generation timings of the first image P1 and the second image P2 in the video capturing mode according to the modification example.

As described above, the first image P1 and the second image P2 may not be generated in the same frame period of time because of constraints on computational processing capability. Therefore, in the present modification example, the resolution of the first image P1 is reduced below the resolution of the imaging signal RD to decrease the burden of image processing.

Specifically, the first image processing unit 52 generates the color first image P1 through the first image processing after reducing the resolution of the imaging signal RD acquired from the imaging sensor 20. The first image processing unit 52 reduces the resolution of the imaging signal RD by, for example, pixel thinning-out. As a result, the first image P1 having a lower resolution than that of the imaging signal RD is obtained.

In the present modification example, the second image processing unit 55 generates the second image P2 without changing the resolution of the imaging signal RD acquired from the imaging sensor 20. Therefore, in the present modification example, since the machine learning-based trained model LM can perform the subject detection even by using an image having a lower resolution than that of the final recording image, the resolution of the first image P1 is lower than the resolution of the second image P2.

In the present modification example, since the burden on the image processing is decreased by reducing the resolution of the first image P1, the first image P1 and the second image P2 are generated in the same frame period of time.

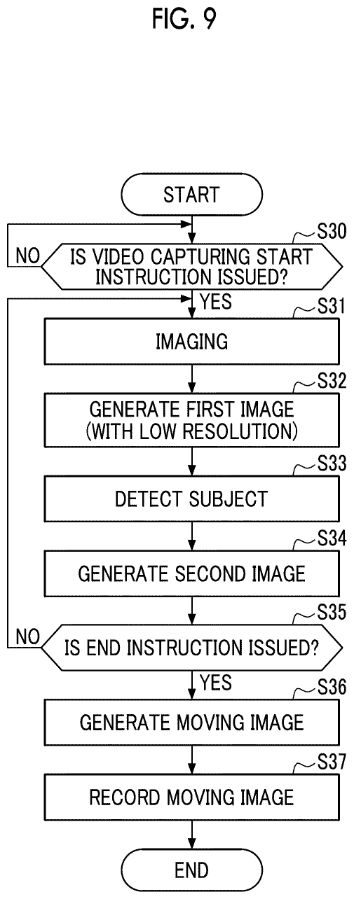

FIG. 9 is a flowchart showing an example of the image generation method in the video capturing mode according to the modification example. FIG. 9 shows an example of a case where the monochrome mode of the film simulation is selected in the video capturing mode according to the modification example.

Next, the main control unit 50 determines whether or not the video capturing start instruction is issued by the user through the operation of the operation unit 13 (step S30). In a case where the video capturing start instruction is issued (step S30: YES), the main control unit 50 controls the imaging control unit 51 to cause the imaging sensor 20 to perform the imaging operation (step S31).

The first image processing unit 52 acquires the imaging signal RD output from the imaging sensor 20 and reduces the resolution of the imaging signal RD, and then performs the first image processing to generate the color first image P1 (step S32).

The subject detection unit 53 detects the subject by inputting the low-resolution first image P1 generated by the first image processing unit 52 into the trained model LM (step S33). In step S33, the subject detection unit 53 outputs the detection result R of the subject, which is output from the trained model LM, to the main control unit 50. For example, the main control unit 50 controls the lens drive control unit 34 based on the detection result R to perform focusing control on the subject.

The second image processing unit 55 performs the second image processing on the same imaging signal RD as the imaging signal RD acquired by the first image processing unit 52 in step S32 to generate the monochrome second image P2 (step S34).

The main control unit 50 determines whether or not the end instruction of the video capturing is issued by the user through the operation of the operation unit 13 (step S35). In a case where no end instruction is issued (step S35: NO), the main control unit 50 returns the processing to step S31 and causes the imaging sensor 20 to perform the imaging operation again. The processing of steps S31 to S34 is repeatedly executed until the main control unit 50 determines that the end instruction is issued in step S35. Steps S31 to S34 are performed within a single frame period.

In a case where the end instruction is issued (step S35: YES), the main control unit 50 causes the image recording unit 56 to generate the recording image PR (step S36). In step S36, the image recording unit 56 generates the recording image PR, which is a moving image, based on the plurality of second images P2 generated by repeatedly executing step S34. Then, the image recording unit 56 records the recording image PR in the memory 42 (step S37).

As described above, in the present modification example, by generating the first image P1 after reducing the resolution of the imaging signal RD, the burden on the image processing is decreased, so that the first image P1 and the second image P2 can be generated in the same frame period of time. Consequently, it is possible to generate the moving image without lowering the frame rate.

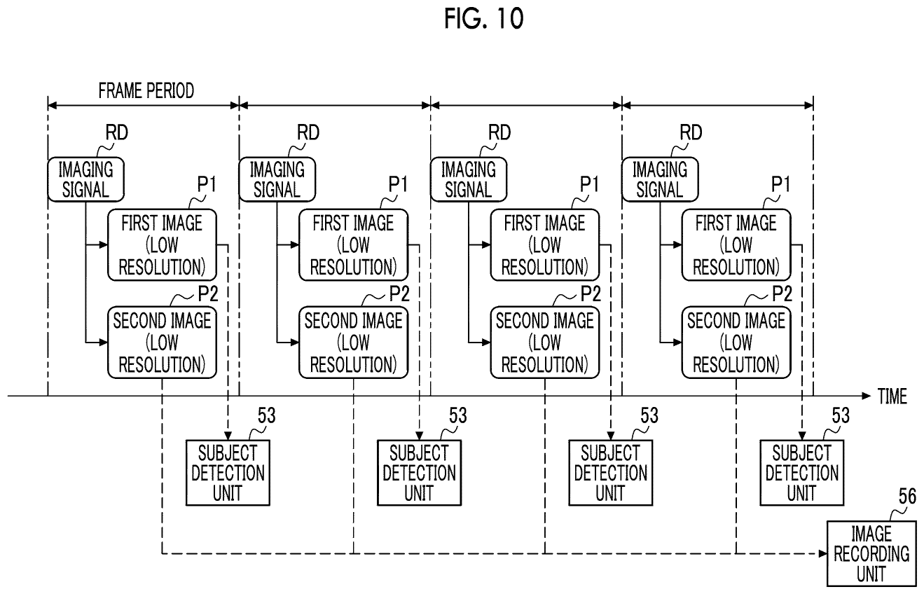

In the above-described modification example, the resolution of the first image P1 is reduced below the resolution of the imaging signal RD. Further, the resolution of the second image P2 may be reduced below the resolution of the imaging signal RD. Specifically, as shown in FIG. 10, the first image processing unit 52 and the second image processing unit 55 generate the first image P1 and the second image P2 after reducing the resolution of the imaging signal RD, respectively. Consequently, the burden on the image processing is further decreased, so that it is possible to generate the first image P1 and the second image P2 more quickly in the same frame period of time.

### Other Modification Examples

In the embodiment and the modification example described above, a case where the monochrome mode is selected in the color tone adjustment such as film simulation has been described, but the technology of the present disclosure is not limited to the monochrome mode and can also be applied to a case where a mode for generating an image having low chroma saturation, such as a classic chrome mode, is selected. That is, the technology of the present disclosure can be applied to a case of making the second image P2 a low-chroma saturation image.

In addition, the technology of the present disclosure can also be applied to a case of making the second image P2 an image having low brightness. This is because, in the trained model LM that has been trained through machine learning using the color image, the detection accuracy of the subject is also decreased for the image having low brightness. Therefore, the technology of the present disclosure is characterized in that the chroma saturation or the brightness of the first image P1 generated by the first image processing unit 52 is higher than that of the second image P2 and of the live view image PL.

Furthermore, the technology of the present disclosure can also be applied to a case where a sepia mode for generating a sepia image is selected. The sepia image is an image generated by multiplying the color difference signal Cr and Cb by zero and then adding a fixed value in a case where the image signal of the color image is represented in the YCbCr format. That is, the first image P1 may be a color image, and the second image P2 and the live view image PL may be sepia images. In the trained model LM that has been trained through machine learning using the color image, the detection accuracy of the subject is also decreased for the sepia image. Therefore, the detection accuracy is improved by performing the subject detection using the color image.

The technology of the present disclosure is not limited to the digital camera and can also be applied to electronic devices such as a smartphone and a tablet terminal having an imaging function.

In the above-described embodiment, various processors to be described below can be used as the hardware structure of the control unit using the processor 40 as an example. The above-described various processors include, in addition to a CPU which is a general-purpose processor that functions by executing software (programs), a processor that has a changeable circuit configuration after manufacturing, such as an FPGA. The FPGA includes a dedicated electrical circuit that is a processor which has a dedicated circuit configuration designed to execute specific processing, such as PLD or ASIC, and the like.

The control unit may be configured with one of these various processors or may be configured with a combination of two or more of the processors of the same type or different types (for example, a combination of a plurality of FPGAs or a combination of a CPU and an FPGA). Alternatively, a plurality of control units may be configured with one processor.

A plurality of examples in which a plurality of control units are configured with one processor are conceivable. As a first example, there is an aspect in which one or more CPUs and software are combined to configure one processor and the processor functions as a plurality of control units, as typified by a computer such as a client and a server. As a second example, there is an aspect in which a processor that implements the functions of the entire system, which includes a plurality of control units, with one IC chip is used, as typified by system on chip (SOC). In this way, the control unit can be configured by using one or more of the above-described various processors, as the hardware structure.

Moreover, more specifically, it is possible to use an electrical circuit in which circuit elements such as semiconductor elements are combined, as the hardware structure of these various processors.

The contents described and shown above are detailed descriptions of parts related to the technology of the present disclosure and are merely an example of the technology of the present disclosure. For example, the above description related to configurations, functions, actions, and effects is description related to an example of the configurations, functions, actions, and effects of the parts related to the technology of the present disclosure. Therefore, it goes without saying that unnecessary parts may be deleted, new elements may be added, or replacements may be made for the contents described and shown above within the scope that does not depart from the gist of the technology of the present disclosure. Moreover, in order to avoid confusion and facilitate understanding of the parts related to the technology of the present disclosure, description related to common technical knowledge and the like that do not require particular description to enable implementation of the technology of the present disclosure is omitted from the contents described and shown above.

All documents, patent applications, and technical standards described in the present specification are incorporated by reference into the present specification to the same extent as in a case where the individual documents, patent applications, and technical standards were specifically and individually stated to be incorporated by reference.

What is claimed is:

1. An image generation method comprising:
an imaging step of acquiring an imaging signal output from an imaging element;
a first generation step of using the imaging signal to generate a first image through first image processing;
a detection step of detecting a subject within the first image by using the first image via a trained model trained through machine learning; and
a second generation step of using the imaging signal to generate a second image through second image processing different from the first image processing.

2. The image generation method according to claim 1, further comprising:
a reception step of receiving an imaging instruction from a user,
wherein, in the second generation step, the second image is generated in a case where the imaging instruction is received in the reception step.

3. The image generation method according to claim 1, further comprising:
a display step of changing the first image to create a live view image and displaying the live view image and a detection result of the subject detected in the detection step on a display device.

4. The image generation method according to claim 3,
wherein, in the display step, the live view image is displayed by generating a display signal of the live view image based on an image signal constituting the first image.

5. The image generation method according to claim 3,
wherein, in the second generation step, a color of the second image is made substantially the same as a color of the live view image.

6. The image generation method according to claim 3,
wherein chroma saturation or brightness of the first image is higher than that of the second image and of the live view image.

7. The image generation method according to claim 1, further comprising:
a recording step of recording the second image on a recording medium as a still image.

8. The image generation method according to claim 1,
wherein the first image has a lower resolution than that of the imaging signal or the second image.

9. The image generation method according to claim 1,
wherein, in the imaging step, the imaging signal is output from the imaging element for each frame period,
in the first generation step and the second generation step, the first image and the second image are generated by using the imaging signal of the same frame period of time, and
the first image has a lower resolution than that of the imaging signal or the second image.

10. The image generation method according to claim 9,
wherein the second image has a lower resolution than that of the imaging signal.

11. The image generation method according to claim 1,
wherein, in the imaging step, the imaging signal is output from the imaging element for each frame period,
in the first generation step, the first image is generated by using the imaging signal of a first frame period of time, and
in the second generation step, the second image is generated by using the imaging signal of a second frame period of time different from the first frame period of time.

12. The image generation method according to claim 9,
wherein the second image is a moving image.

13. The image generation method according to claim 9,
wherein chroma saturation or brightness of the first image is higher than that of the second image.

14. The image generation method according to claim 1,
wherein the trained model is a model trained through machine learning using a color image as training data,
the first image is a color image, and
the second image is a monochrome image or a sepia image.

15. A processor that acquires an imaging signal output from an imaging apparatus, the processor configured to execute:
a first generation process of using the imaging signal to generate a first image through first image processing;
a detection process of detecting a subject within the first image by using the first image via a trained model trained through machine learning; and
a second generation process of using the imaging signal to generate a second image through second image processing different from the first image processing.

16. A non-transitory computer-readable storage medium storing a program used by a processor that acquires an imaging signal output from an imaging apparatus, the program causing the processor to execute:
a first generation process of using the imaging signal to generate a first image through first image processing;
a detection process of detecting a subject within the first image by using the first image via a trained model trained through machine learning; and
a second generation process of using the imaging signal to generate a second image through second image processing different from the first image processing.
